(19) United States
(12) Patent Application Publication
(10) Pub. No.: US 2024/0219196 A1
(43) Pub. Date: Jul. 4, 2024

(54) SYSTEM AND METHOD FOR VALIDATING HIGH-DEFINITION MAPS

(71) Applicant: EMTECH GROUP INC., Toronto (CA)

(72) Inventors: Ansh DAVID, Richmond Hill (CA); Michael GAILLING, Oshawa (CA); Farsam FARZADPOUR, Aurora (CA); Spencer REUBEN, Holland Landing (CA); Toni JARDINI, Niagara Falls (CA)

(21) Appl. No.: 18/220,106

(22) Filed: Jul. 10, 2023

Related U.S. Application Data
(60) Provisional application No. 63/437,068, filed on Jan. 4, 2023.

(51) Int. Cl. G01C 21/00

(52) U.S. Cl. CPC G01C 21/3822; G01C 21/3896

(57) ABSTRACT

Systems and methods for validating maps for use with autonomous vehicles are provided. Variabilities between an HD map and previous versions of the HD map may be identified. Test cases may be generated based on the HD map, testing requirements, and previously validated lane segments. An optimized set of test cases may be selected based on variabilities and unvalidated lane segments in the HD map. The optimized set of test cases may be subdivided among a plurality of execution instances which may be executed in parallel.

### CROSS-REFERENCE TO RELATED APPLICATIONS

This claims the benefit of U.S. Provisional Patent Application No. 63/437,068, filed Jan. 4, 2023, the entire contents of which are incorporated herein by reference.

### FIELD

This relates generally to computerized systems for validating high-definition maps, and in particular systems for use with autonomous vehicles.

### BACKGROUND

Autonomous vehicles (AVs) are vehicles that are capable of sensing their surrounding environment and moving safely with little to no human input. AVs make use of a variety of sensors and other components and data (e.g. radar, sonar, GPS, high-definition maps, odometers, accelerometers, optical devices, and the like) to perceive their surroundings.

Autonomous driving systems require accurate localization, including but not limited to accuracy within a few centimeters at confidence levels above 95%. The use of high-definition (HD) map data is significant in increasing confidence levels within autonomous vehicle applications, thereby making safe driving decisions and the safe operation of AVs more likely.

HD Maps are constructed by an array of sensors (such as LiDARs, digital cameras, and GPS) and contain details which are normally not presented on traditional maps. Nevertheless, HD maps may have gaps in detail and other defects, even if provided by third parties specializing in building HD maps. Such gaps and defects may impair localization, and therefore represent vulnerabilities to the underlying reliability of the autonomous driving system. Owing to these vulnerabilities, HD maps should be validated against real-world data (e.g., Google Street View images, Aerial Imagery, and the like). Such validation may include the selection of map routes for validating the map features.

Although many localization techniques have been proposed, with a focus on achieving high accuracy in autonomous driving, a common methodology to effectively validate the HD map itself is still missing.

Accordingly, there is a need for systems which fully evaluate an HD map and improve its quality (e.g. by identifying and filling gaps) while striking an appropriate balance against testing time constraints.

### SUMMARY

According to an aspect, there is provided a method of validating a map for use with an autonomous vehicle, the method comprising: obtaining a high definition (HD) map and a map schema associated therewith; comparing, by a processor, said HD map to said map schema; storing said HD map in a map database based on said comparing; identifying one or more variabilities in said HD map; generating, by the processor, a map graph based on said HD map, said map graph comprising nodes representing lane segments and edges representing connections between said lane segments; generating, by the processor, a plurality of test cases based on the map graph, testing requirements, and at least one previously validated lane segment; selecting an optimized set of test cases based on said plurality of generated test cases, said one or more variabilities in said HD map, and unvalidated lane segments in said HD map; generating a plurality of execution instances, said optimized set of test cases being subdivided among said plurality of execution instances; and validating said HD map by executing said plurality of execution instances.

According to another aspect, there is provided a system for performing map validation, the system comprising: one or more processors; a non-transitory computer-readable storage medium having stored thereon computer-executable instructions that, when executed by the one or more processors, cause the one or more processors to: obtain a high definition (HD) map and a map schema associated therewith; compare said HD map to said map schema; store said HD map in a map database based on said comparing; identify one or more variabilities in said HD map; generate a map graph based on said HD map, said map graph comprising nodes representing lane segments and edges representing connections between said lane segments; generate a plurality of test cases based on the map graph, testing requirements, and at least one previously validated lane segment; select an optimized set of test cases based on said plurality of generated test cases, said one or more variabilities in said HD map, and unvalidated lane segments in said HD map; generate a plurality of execution instances, said optimized set of test cases being subdivided among said plurality of execution instances; and validate said HD map by executing said plurality of execution instances.

Other features will become apparent from the drawings in conjunction with the following description.

### BRIEF DESCRIPTION OF DRAWINGS

In the figures which illustrate example embodiments,

FIG. 1 is a block diagram depicting example components of a map validation system;

FIG. 2 is a block diagram depicting components of an example server, vehicle, or client computing device;

FIG. 3 depicts a simplified arrangement of software at a server or client computing device;

FIG. 4 is an illustration of an example variation point and associated variants;

FIG. 5 is a block diagram depicting components of an example map validation process;

FIG. 6A is an expanded view of components of the data mapping and analysis process;

FIG. 6B is an expanded view of the test case generation process;

FIG. 7A depicts an example tree graph, and FIG. 7B is a table of the corresponding lengths of nodes (i.e. lane segments);

FIG. 7C is an illustration of a selected sequence of nodes for each leaf to have a minimum number of repeated nodes;

FIG. 7D is an illustration of a set of test cases with a minimum number of repeated lane segments covering the whole tree;

FIG. 8A is an illustration of disjoint sets (depicted as coloured nodes) obtained from an intersection of all leaves;

FIG. 8B is a depiction of the minimum number of nodes for each leaf to prevent redundancy;

FIG. 8C is a depiction of the set of test cases with zero number of repeated lane segments covering the whole tree; and

FIG. 9 depicts an example output schema for execution instances for the JSON format.

### DETAILED DESCRIPTION

Known HD map validation techniques frequently face a trade-off between testing time constraints and completeness. The most common methodology for validation of map features is performing a so-called “brute force” or exhaustive approach to select routes for validating map data features against real-world data. Further examples of map validation techniques include model-based, deep learning-based, and Spatio-temporal correlation-based approaches. These approaches only focus on comparing HD map features against sensor data to validate the HD map and overlook the need for an optimized route selection process. Therefore, these methodologies suffer from the selection of repeated (or partially repeated) routes for validation, which is not time- or resource-efficient from a testing perspective.

In addition, the brute-force-based approaches might not offer full map coverage for a given limited testing time. Therefore, an optimized selection of the routes for validating the map features is crucial in both reducing the testing costs and validating maps in accordance with time constraints. Thus far, there has been little development towards route selection processes which promise sufficient performance for such purposes.

In some approaches for the validation of HD maps, variability in the map is not taken into account for the validation process. In other words, the entire map is re-considered for validation when an updated version of the map for the same region is released. This approach may be inefficient and time-consuming, as there might not be any need to validate unchanged and previously validated regions of the map in the absence of a new requirement attached to it. Such inefficiencies lead to having low testing coverage in the map data validation process and a significant waste of testing resources.

Some embodiments may relate to a solution which may ensure full or near-full map validation coverage within a reasonable testing time. An optimized selection of the routes for validating given map features based on the requirements may be possible. In addition, some embodiments may enable the efficient use of testing resources by identifying variabilities in the HD map and allowing parallel execution of the test cases in the form of execution instances.

The present disclosure uses a number of specific terms herein in relation to some embodiments, as described below.

A map graph may refer to the modelling of an HD map as a graph of road segments, where the nodes are defined as lane segments and graph edges denote the connectivity between lane segments. In some embodiments, map graphs may include a direction which denotes how each lane segment is accessed or accessible.

A tree may be defined as a connected graph having no cycles and which may obtained from or based on a map graph.

A spanning tree may refer to a subgraph of a given connected graph (G) which is a tree a visits every node. Thus, a minimum spanning tree may refer to a shortest path for visiting all lane segments.

A lane segment may refer to the smallest element of a road network in a lane-level presentation of HD map data. A map version may refer to a representation of the same region at different points in time. In other words, versions of a map represent the same region at different times. The map may or may not have changed in different versions.

A variation point may refer to a specific point at which variability occurs. For example, for a selected version of a map, a map variation point may be defined as a specific map feature upon which variabilities are build. For example, a “lane segment” may be a variation point, as described further herein.

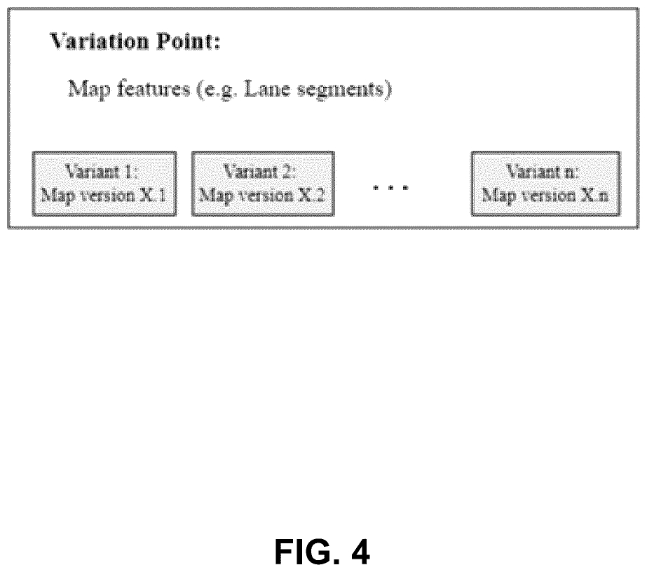

A map variant may refer to a set of possible alternative map variabilities. For example, if a map has a variation point, a map variant may refer to different versions of the map with respect to that variation point. As depicted in FIG. 4A, if X denotes a map of a specific region, the map variants may be X.1, X.2, . . . , X.n, where each map may cover the same region but may include different numbers of available map features, or with different data corresponding to available features in the map. For example, X.1 may be a map of the same region with a new feature such as a “traffic sign” having been added, and X.2 may be a map of the same region where the number of existing “traffic signs” has been changed.

A map feature may be a characteristic of an HD map. For example, lanes, traffic signs (as noted above), buildings, pedestrian crosswalks, curbs, and the like are all examples of map features.

Map attributes are components of a map which describe the map features. For example, for a “lane” feature, map attributes might include the lane speed limit, the lane length, the lane width, and the like.

A map route is described herein is a path between two locations on the map. In some embodiments, a map route comprises a set of lane segments.

A map schema refers to a representation of a map data structure. A map schema may describe the type and/or values that each map element (e.g. lane segments, road edges, road markers) or attribute can have. For example, lane segments may have attributes such as curvature, heading, elevation profile, location, widths, and the like. Road edges may have attributes such as width, paved, unpaved, and the like. Road markers may have attributes such as “solid lines”, “dashed lines”, or the like.

A test case refers to a sequence of lane segments. In some embodiments, a test case is an ordered set of lane segments which are to be validated. Each test case may represent a route in the HD map being validated.

The test size refers to the amount of time required to execute a test case. For example, this can include the time required for a vehicle to drive (in a simulated environment) on the route associated with the test case. In some embodiments, test size may be calculated based on the length of the test case (e.g. the route length) and the maximum permissible speed of the vehicle on the lane segments within the route.

An execution instance is a set of test cases that can be executed independently of other test cases. In some embodiments, each test execution instance my contain an ordered set of test cases and their corresponding transition routes.

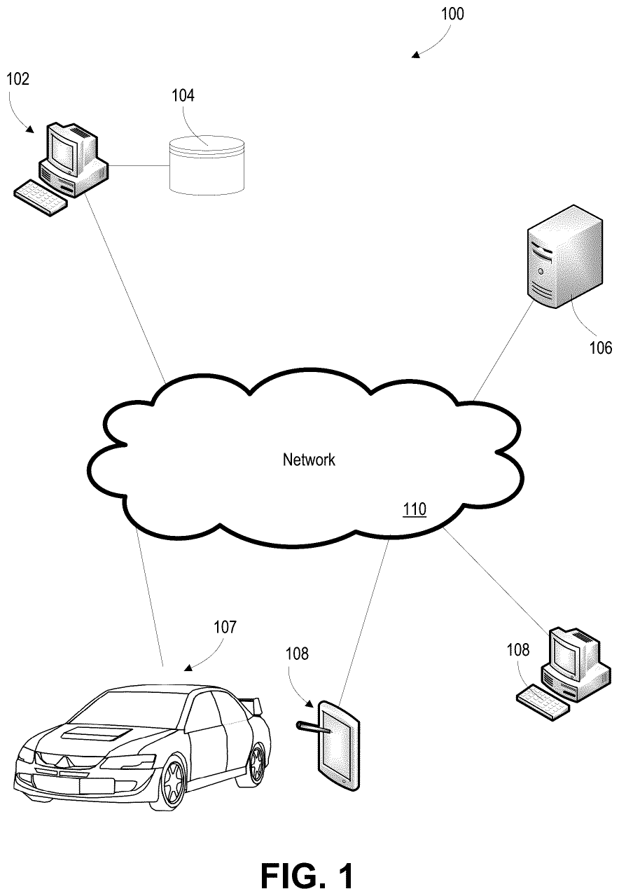

Various embodiments described herein make use of computing systems to perform various operations. FIG. 1 is a block diagram depicting example components of a map validation system. As depicted, map validation system 100 includes at least one server 102 with a data storage 104 such as a hard drive, array of hard drives, network-accessible storage, or the like; at least one web server 106, a plurality of client computing devices 108, at least one vehicle 107. Server 102, web server 106, client computing devices 108, and vehicle 107 are in communication by way of a network 110. More or fewer of each device are possible relative to the example configuration depicted in FIG. 1. In some embodiments, one or more elements of validation system 100 may be omitted.

Network 110 may include one or more local-area networks or wide-area networks, such as IPv4, IPV6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE networks.

As shown, server 102 and web server 106 are separate machines, which may be at different physical or geographical locations. However, server 102 and web server 106 may alternatively be implemented in a single physical device.

As will be described in further detail, server 102 may be connected to a data storage 104. In some embodiments, web server 106 hosts a website 400 accessible by client computing devices 108 and/or vehicle 107. Web server 106 is further operable to exchange data with server 102 such that data associated with client computing devices 108 or vehicle 107 can be retrieved from server 102 and utilized in connection with map validation.

Server 102 and web server 106 may be based on Microsoft Windows, Linux, or other suitable operating systems. Client computing devices 108 may be, for example, personal computers, smartphones, tablet computers, vehicle 107, or the like, and may be based on any suitable operating system, such as Microsoft Windows, Apple OS X or iOS, Linux, Android, or the like.

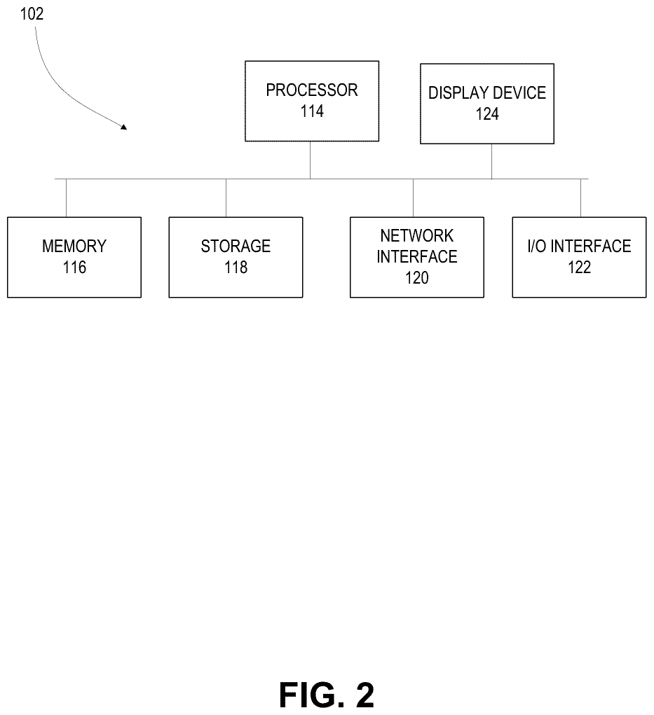

FIG. 2 is a block diagram depicting components of an example server 102, 106, vehicle 107, or client computing device 108. As depicted, each server 102, 106, client device 108, and vehicle 107 includes a processor 114, memory 116, persistent storage 118, network interface 120, and input/output interface 122.

Processor 114 may be an Intel or AMD x86 or x64, PowerPC, ARM processor, or the like. Processor 114 may operate under the control of software loaded in memory 116. Network interface 120 connects server 102, 106, vehicle 107, or client computing device 108 to network 110. Network interface 120 may support domain-specific networking protocols for vehicle 107. I/O interface 122 connects server 102, 106, or client computing device 108 to one or more storage devices (e.g. storage 104) and peripherals such as keyboards, mice, pointing devices, USB devices, disc drives, display devices 124, and the like.

In some embodiments, I/O interface 122 connects various sensors and other specialized hardware and software used in connection with the operation of vehicle 107 to processor 114 and/or to other computing devices 102, 106, 108. In some embodiments, I/O interface 122 may be used to connect vehicle 107 to other computing devices 102, 106, 108 and provide access to various sensors and other specialized hardware and software within vehicle 107.

In some embodiments, I/O interface 122 may use an OBD2 protocol as the communication interface. In some embodiments, I/O interface 122 may be compatible with protocols such as WiFi, Bluetooth, and other communication protocols.

In some embodiments, sensors and other specialized hardware and/or software used in connection with vehicle 107 may include, for example, any one or more of digital cameras, LiDAR, GPS devices, sensors, and any combination thereof.

Software may be loaded onto server 102, 106, vehicle 107, or client computing device 108 from peripheral devices or from network 106. Such software may be executed using processor 114.

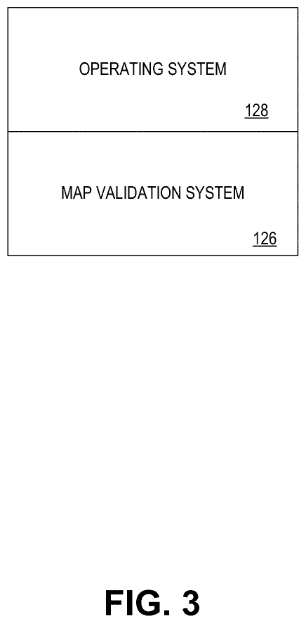

FIG. 3 depicts a simplified arrangement of software at a server 102 or client computing device 108. The software may include an operating system 128 and application software, such as map validation system 126.

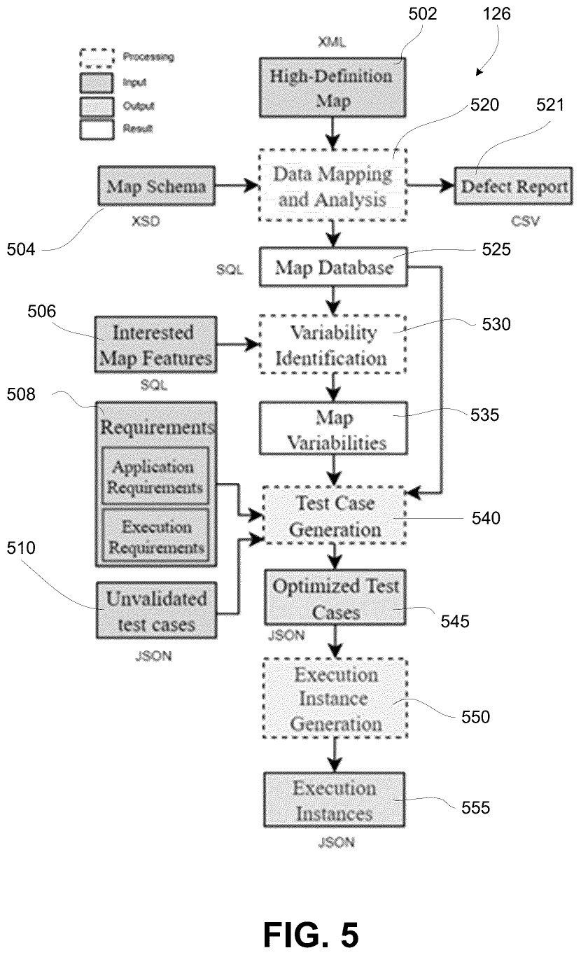

FIG. 5 is a block diagram depicting components of an example map validation system 126. In some embodiments, map validation system may generate a report which outlines defects in an HD map, as well as a set of optimized test cases for validating map features which are grouped into execution instances.

In some embodiments, map validation system 126 accepts inputs which include one or more of an HD map 502, a map schema 504, a set of interested map features 506, a set of requirements 508, and/or a list of unvalidated lane segments 510.

In some embodiments, HD map 502 is the current version of the map which is to be validated against requirements 508. The HD map input format may be OpenDRIVE, which is XML files, and is an open format specification which allows for describing a road network's logic including lane-level map representations. In some embodiments, the HD map 502 format may be Apollo OpenDRIVE, OpenStreetMap (OSM), Route Network Definition File (RNDF), or the like. In some embodiments, a map parser may be configured to convert HD map 502 into a map database 525.

In some embodiments, map schema 504 is an XML schema definition (XSD) file. Map schema 504 might be provided by the map supplier. Map schema 504 may be used to validate the structure and elements of the XML file representing HD map 502, because XSD describes both format and structure of the data presented in XML files.

In some embodiments, interested map features 506 are features of the map which are selected for validation or for identifying the variability in the map such as lane segments.

In some embodiments, requirements 508 may be testing requirements which include application requirements 508a and/or execution requirements 508b. In some embodiments, application requirements 508a describe essential conditions for map features that are required for the intended functionality of the application. For example, an application requirement could be the continuity of lane segments of the roads in order to ensure safe operation of autonomous vehicles. Another example of application requirement could be the speed limit for a given road segment (e.g. the legal maximum at which a vehicle may travel on a given segment of the road). The features which are important for the map application (i.e. features which have specific requirements) may be selected as variational points for variability identification and may be used to generate corresponding test cases.

In some embodiments, execution requirements 508b are requirements which are based on requirements for the execution of test cases either in the real world or in a simulated environment. An example execution requirement could be having a constraint on the minimum or maximum length of generated routes due to limitations of the execution platform. Another example of execution requirement 508b could be the required number of execution instances to enable parallel execution of test cases.

In some embodiments, unvalidated test cases 510 (sometimes referred to as unvalidated lane segments) may be a list of lane segments or nodes from previous versions of a map which require validation. These lane segments or nodes may be, for example, the result of test execution failures or unexecuted test cases due to, for example, a lack of time in a previous execution process. In some embodiments, a new version of the map may represent the same region of the HD map at a different time. As such, identified map variabilities may cover some or all of the changes to the new map lane segments.

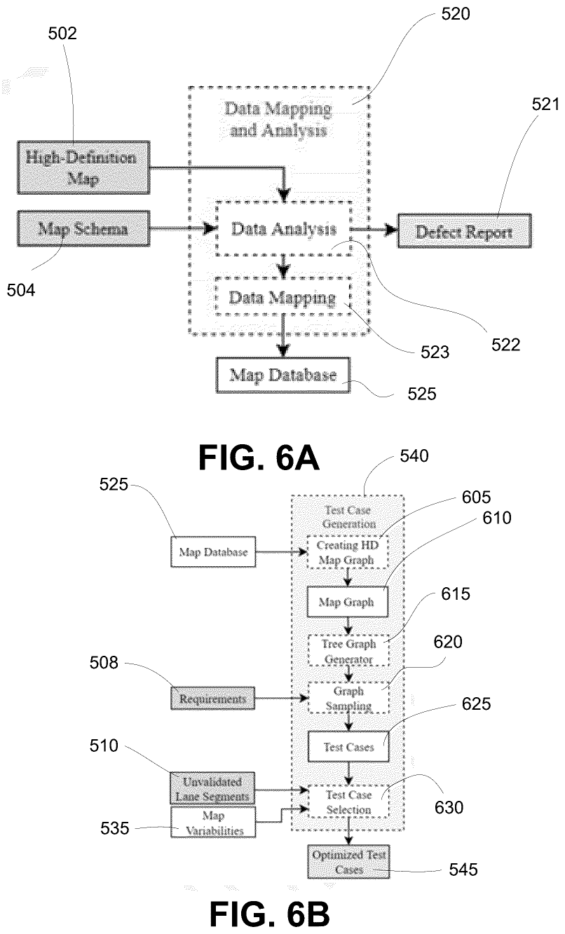

FIG. 6A is an expanded view of components of the data mapping and analysis process 520. At block 520, data mapping and analysis is performed. In some embodiments, map validation system 126 may receive HD map data 502 and a corresponding map schema 504. In some embodiments, map schema 504 may be in XSD (XML Schema Definition) format. Data mapping and analysis 520 may generate a defect report 521. Data mapping and analysis 520 may also store a copy of some or all previous versions of map 502 in map database 525. In some embodiments, these previous versions can be used to retrieve map variants for identifying variability in the map.

In some embodiments, at block 522, HD map 520 data is validated against its defined schema 504 in order to identify and possibly eliminate any errors such as, for example, missing mandatory values, invalid characters, and/or incorrect formats in the attributes/elements of the HD map 502. Additionally, other defects may be detected at block 520, including but not limited to identifying any discontinuities in the lane-level network of the HD map 502 data. This may occur as a result of an application requirement 508a requiring lane-level networks to be connected to self-driving vehicles. Once validation of the map schema 504 is complete, defect report 521 may be generated. In some embodiments, defect report 521 may be in a text-based format, such as comma-separated values (CSV).

At block 523, the map data is converted into an internal and/or proprietary representation of the map database 525 for the generation of test cases. This may be done, for example, by developing a map parser. As the size of the map database 525 increases, there may be greater demands for accessible memory. As such, due to hardware limitations (e.g. the maximum capacity of the operating system 128), such increased demands may cause a performance bottleneck for the parser. In some embodiments, a multithreaded parsing and thread synchronization mechanism may be utilized to compensate for memory shortages. Moreover, to resolve processing overhead and to enhance parsing performance, parsed information may be stored in a list structure and then pushed to the map database 525 (e.g. an SQL server) when the number of records reaches a threshold value.

At block 530, variabilities in the map may be identified. Considering time limitations of the testing process, and the desire to improve testing coverage, existing test cases of HD map 502 may be reused for validated regions. This may lead to a significant reduction in the testing resources required and may enhance the efficiency of the validation process. This may contrast with conventional validation approaches in which the whole map 502 is considered for validation with the delivery of every version of the map (i.e. map variants).

In some embodiments, variabilities 535 in the map are identified by utilizing map database 525 which includes some or all previous versions of HD map 502 and selecting interested map features 506 as the variational point for available map variants. The interested map features 506 may be selected from existing features of HD map 502 and may be used to identify variabilities in the HD map 502.

FIG. 6B is an expanded view of test case generation process 540. At block 540, a focus may be placed on an approach for route planning which enables the generation of optimized test cases (routes) from HD maps 502 to validate map features. In some embodiments, test cases 625 are the map routes which need to be validated. In some embodiments, test case generation 540 may include one or more of creating an HD map graph 605, generating a tree graph 615, sampling from graphs 620, and selecting test cases 630.

At block 605, a directed map graph 610 may be built using lane-level information of the HD map 502. In some embodiments, the directed map graph 610 may be obtained based on connectivity among lane segments and the direction of travel on the lane segments.

At block 615, a tree graph may be generated based on map graph 610. In some embodiments, the tree graph is built by identifying a root node. There are a number of ways of measuring network centrality in order to identify a root node. For example, “betweenness centrality” may be selected to identify the root node. In some embodiments, betweenness centrality may be obtained by identifying all of the shortest paths between all pairs of nodes (i.e. lane segments) and calculating how many times each node falls on one of these paths. As such, the number of times a node appears in-between the shortest path is counted. The node with the highest betweenness may be selected as the root node in some embodiments. Using the root node as a starting point, a tree structure may be created utilizing a breadth-first search approach. For example, such a search may begin with the identified tree root and then explore all nodes at the present depth before moving on to nodes at the next depth level.

At block 620, graph sampling may be employed to remove or lower redundancy in generated test cases. Generated test cases will typically have redundancy, in other words, the existence of repeated nodes, which usually leads to waste or inefficient use of testing resources. However, it may not always be possible to remove or lower redundancy in generated test cases due to requirements 508. For example, constraints on the maximum or minimum required route length might prevent the achievement of zero redundancy among generated test cases 625.

There are several possible strategies or approaches for increasing the efficiency of the validation. The first approach is based on the minimum redundancy, which may generate a set of test cases with minimum repeated nodes covering all graph nodes and satisfying the required maximum and minimum test case length. A second approach is based on having zero redundancy in the generated test cases. In the second approach, the minimum requirements (for example, the upper limit on minimum required route length) may be identified to achieve zero redundancy, and then test cases may be generated accordingly.

Let G=(V, ε) denote the map tree where V is the set of nodes (lane segments), and ε is a set of directed edges. A set of tree leaves (nodes with a degree equal to one) may be defined as

$${T}_{L} = \{ {l}_{1} , {l}_{1} , ... , {l}_{p} \} \qquad ( 1 )$$

where lᵢ is the i-th leaf of the tree and p∈ [symbol] is the number of tree leaves.

In the minimum redundancy approach, an approach is developed for the generation of the test cases to achieve minimum redundancy while having a constraint on the length of the test cases. The notation sₘ may be defined as the minimum required length for each test case (route), s_{M} as the maximum allowable length for each test case (route), and Nᵢ as a list of all nodes connecting the root node (ρᵣ) to the i-th leaf node (ρᵢ), is given by

$${N}_{i} = ( {q}_{1} , {q}_{1} , ... , {q}_{{d}_{i}} ) \qquad ( 2 )$$

where q₁=ρᵢ, q_{d}=ρᵣ dᵢ=|Nᵢ| is the size of Nᵢ, q_{K}∈V. Thus, V can be also defined in terms of Nᵢ, by

$$V = {{⋃}^{p}}_{i = 1} ( {{⋃}^{{d}_{i}}}_{j = 1} {N}_{i} ( j ) ) \qquad ( 3 )$$

where Nᵢ(j) is the j-th element of Nᵢ.

A function S(qᵢ) may be defined to calculate the length of i-th node. For each graph leaf lᵢ⊆T_{L}, we traverse the leaf (Nᵢ) in the reverse direction from the leaf node (ρᵢ) toward the root node (ρᵣ) and add up the length of each visited node (qₖ) in Nᵢ until the minimum node length is achieved. Let's define kᵢ≤dᵢ such that it satisfies the following inequality (constraint)

$${\sum }_{j = 1}^{{k}_{i}} S ( {N}_{i} ( j ) ) \leq {s}_{m} \qquad ( 4 )$$

A set of nodes for lᵢ may be defined such that it satisfies minimum length requirements, defined as

$${γ}_{i} = ( {N}_{i} ( 1 ) , ... , {N}_{i} ( {k}_{i} ) ) \qquad ( 5 )$$

where |γᵢ|=kᵢ.

By considering all leaves, we can define

$${Γ}_{0} = {{⋃}^{p}}_{i = 1} ( {{⋃}^{{k}_{i}}}_{j = 1} {γ}_{i} ( j ) ) \qquad ( 6 )$$

where Γ₀ is the collection of all traversed nodes for all leaves such that satisfies the minimum required test case length (sₘ).

Let's define the Ψᵢ through traversing the leaf (lᵢ) in the reverse direction toward the root node (ρᵣ) and keep adding nodes until the next node q_{ψ}_{ᵢ}₊₁∉γᵢ either does exist in Γ₀ or in any generated test cases. The condition q_{ψ}_{ᵢ}₊₁∉γᵢ assume that the minimum length is reached for the generation of Ψᵢ. Thus, we have

$${Ψ}_{i} = ( {q}_{1} , ... , {q}_{{k}_{i}} , {q}_{{k}_{i} + 1} , … , {q}_{{ψ}_{i}} ) \qquad ( 7 )$$

where q₁=ρᵢ and ψᵢ≤dᵢ. To assure minimum and maximum constraints are satisfied in the test case generation process 540, we might need to group the nodes for each leaf. In some embodiments, this may be done through an optimization process described below.

Let's define function S(x)∈ [symbol] such that it calculates the sum of all elements in x, as follows

$$S ( x ) = {\sum }_{i = 1}^{\vert x \vert} x ( i ) \qquad ( 8 )$$

where |x| is the size of x and let G_{i,1} be the first group associated with Ψᵢ, defined as

$${G}_{i , 1} = ( {Ψ}_{i} ( 1 ) , … , {Ψ}_{i} ( {g}_{1} ) ) \qquad ( 9 )$$

where g₁≤ψᵢ and sₘ≤S(G_{i,1})≤s_{M}.

Similarly, we can define G_{i,2} as

$${G}_{i , 2} = ( {Ψ}_{i} ( {g}_{1} + 1 ) , {Ψ}_{i} ( {g}_{1} + 2 ) , … , {Ψ}_{i} ( {g}_{2} ) ) \qquad ( 10 )$$

where g₁≤(ψᵢ−g₁) and sₘ≤S(G_{i,2})≤s_{M}.

Proceeding similarly for n-th group, we have

$${G}_{i , {n}_{i}} = ( {Ψ}_{i} ( {g}_{{n}_{i} - 1} + 1 ) , {Ψ}_{i} ( {g}_{{n}_{i} - 1} + 2 ) , … , {Ψ}_{i} ( {g}_{{n}_{i}} ) ) \qquad ( 11 )$$

where gₙ_{ᵢ}≤(ψᵢ−Σⱼ₌₁ⁿ^{ᵢ}⁻¹gⱼ) and sₘ≤S(G_{i,n}_{ᵢ})≤s_{M}.

Let Xᵢ be a cost function associated with i-th leaf, defined as

$${X}_{i} ( {G}_{i , 1} , {G}_{i , 2} , … , {G}_{i , {n}_{i}} ) = S ( {Ψ}_{i} ) - {\sum }_{j = 1}^{{n}_{i}} S ( {G}_{i , j} ) \qquad ( 12 )$$

The optimized number of groups and number of elements for each group (g₁, g₂, . . . , gₙ_{ᵢ}) for i-th leaf is obtained by minimizing the following function,

$${H}_{i} = {min}_{\{ {g}_{1} , {g}_{2 , … , {g}_{{n}_{i}} , {n}_{i}} \}} {X}_{i} \qquad ( 13 )$$

Subjected to

$${s}_{m} \leq S ( {G}_{i , j} ) \leq {s}_{M} for j = [ 1 , 2 , … , {n}_{i} ] \qquad ( 14 )$$

and

$$⌈ \frac{S ( {Ψ}_{i} )}{{s}_{M}} ⌉ \leq {n}_{i} \leq ⌈ \frac{S ( {Ψ}_{i} )}{{s}_{m}} ⌉ \qquad ( 15 )$$

where the operator ┌x┐ is defined as the smallest integer that is more than x. Therefore, for the i-th leaf, we will have nᵢ groups that represent the associated test cases are determined as follows:

$${T}_{i , 1} = ( {Ψ}_{i} ( 1 ) , {Ψ}_{i} ( 2 ) , … , {Ψ}_{i} ( {g}_{1} ) ) \qquad ( 16 )$$

and

$${T}_{i , 2} = ( {Ψ}_{i} ( {g}_{1} + 1 ) , {Ψ}_{i} ( {g}_{1} + 2 ) , … , {Ψ}_{i} ( {g}_{2} ) ) \qquad ( 17 )$$

Proceeding in a similar way, for nᵢ-th test case of the i-th leaf, we will have

$${T}_{i , {n}_{i}} = ( {Ψ}_{i} ( {g}_{{n}_{i} - 1} + 1 ) , {Ψ}_{i} ( {g}_{{n}_{i} - 1} + 2 ) , … , {Ψ}_{i} ( {g}_{{n}_{i}} ) ) \qquad ( 18 )$$

Let's define the set Zᵢ as all test cases generated from the i-th leaf with minimum node repetition that satisfies the minimum and maximum required test case lengths, defined as

$${Z}_{i} = \{ {T}_{i , 1} , {T}_{i , 2} , … , {T}_{i , {n}_{i}} \} \qquad ( 19 )$$

thus, the set Γᵢ is defined as

$${Γ}_{i} = {Γ}_{i - 1} ⋃ {T}_{i} \qquad ( 20 )$$

where U is the union operator. Therefore, the final set of generated test cases with minimum redundancy will be

$${T}_{M} = \{ {Z}_{1} , {Z}_{2} , … , {Z}_{y} \} \qquad ( 21 )$$

where y is the total number of test cases determined by y=Σⱼ₌₁^{p}hⱼ

Using this approach, three possible scenarios can be addressed by an appropriate selection of sₘ and s_{M}.

In the first scenario, there is a constraint on the minimum length of the test cases. For this scenario, we select the following parameters for the implementation of this approach as

$${s}_{m} = cte ( given )$$

$${s}_{M} = ∞$$

In the second scenario, there is a constraint on the maximum length of the test cases. Thus, we have

$${s}_{m} = 0$$

$${s}_{M} = cte ( given )$$

In the third scenario, there are constraints on both the minimum and maximum length of the test cases. Thus, we have

$${s}_{m} = cte ( given )$$

$${s}_{M} = cte ( given )$$

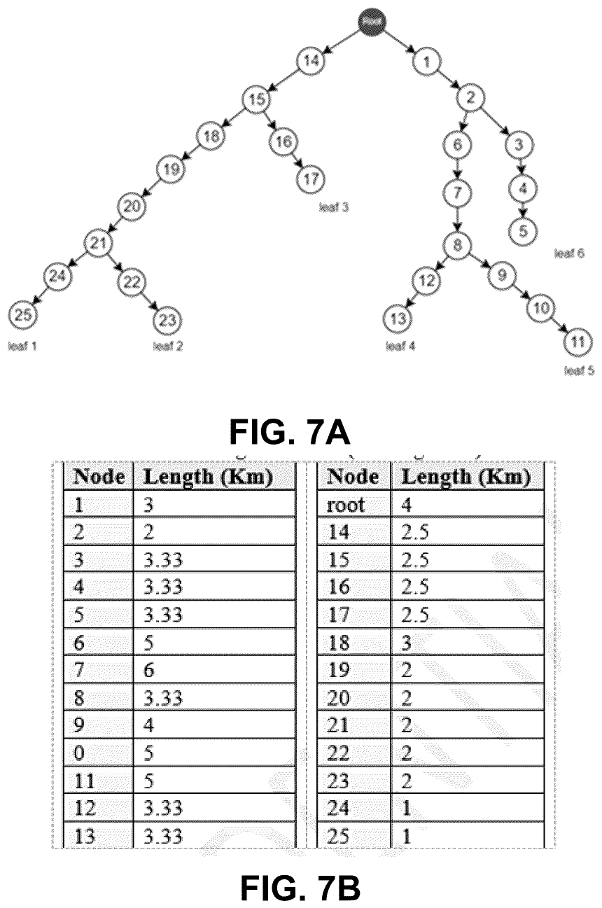

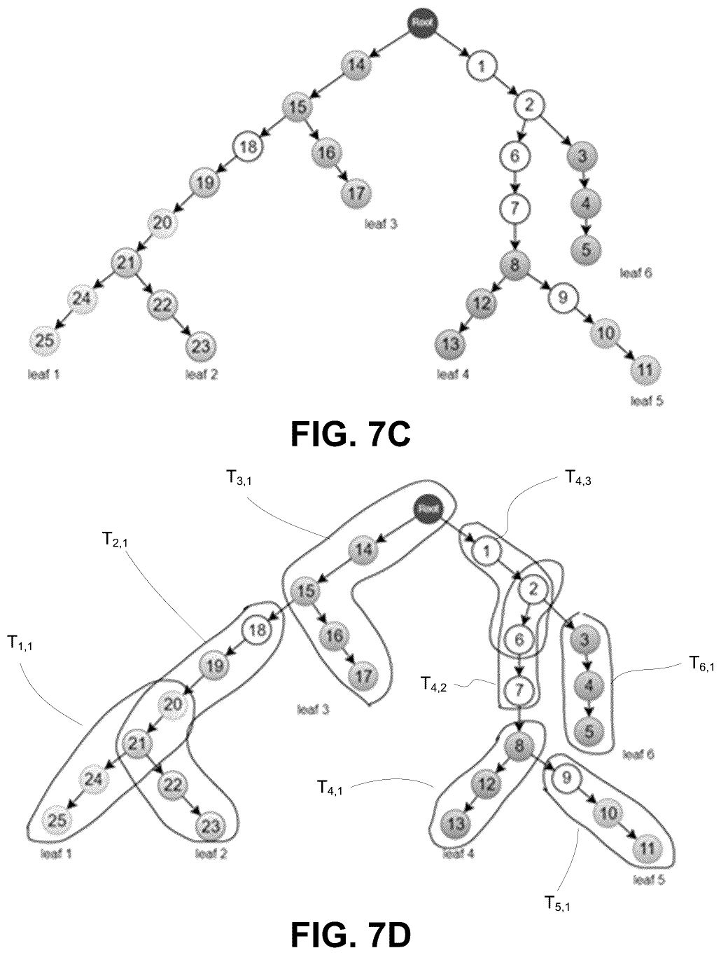

FIG. 7A depicts an example tree graph, and FIG. 7B is a table of the corresponding lengths of nodes (i.e. lane segments). The following is an example process for generating a set of test cases such that it covers all nodes and has a minimum number of repeated nodes (lane segments) while satisfying a minimum (sₘ) and maximum (s_{M}) length for each test case, as described by the third scenario above.

First, the process may identify the tree leaves as T_{L}={l₁, l₁, . . . , l₆} and assume the length of each lane segment (node) is such that by satisfying the minimum length (sₘ) for each leaf, we have the following sets:
γ₁=(25,24,21,20), γ₂=(23,22,21,20,19), γ₃=(17,16,15,14), γ₄=(13,12,8), γ₅=(11,10), and γ₆=(5,4,3)

The result is illustrated in FIG. 7C, where the selected sequence of nodes for each leaf is denoted with different colors. Then, we have
Γ₀={25,24,21,20, 23,22,21,20,19,17,16,15,14, 13,12,8, 11,10,5,4,3}
   and
ψ₁=(25,24,21,20), ψ₂=(23,22,21,20,19,18), ψ₃=(17,16,15,14,ρᵣ), ψ₄=(13,12,8,7,6,2,1), ψ₅=(11,10,9) , and ψ₆=(5,4,3)

By performing group optimization, we will have

$$\begin{matrix}{n}_{1} = 1 & {G}_{1 , 1} = ( 25 , 24 , 21 , 20 ) \\ {n}_{2} = 1 & {G}_{2 , 1} = ( 23 , 22 , 21 , 20 , 19 , 18 ) \\ {n}_{3} = 1 & {G}_{3 , 1} = ( 17 , 16 , 15 , 14 , {ρ}_{r} ) \\ 2 \leq {n}_{4} \leq 3 & {G}_{4 , 1} = ( 13 , 12 , 8 ) , {G}_{4 , 2} = ( 7 , 6 , 2 ) , {G}_{4 , 3} = ( 6 , 2 , 1 ) \\ {n}_{5} = 1 & {G}_{5 , 1} = ( 11 , 10 , 9 ) \\ {n}_{6} = 1 & {G}_{6 , 1} = ( 5 , 4 , 3 )\end{matrix}$$

From here, the set of test cases with a minimum number of repeated lane segments covering the whole tree (depicted in FIG. 7D) may be determined as follows:
T_{1,1}=(25,24,21,20), T_{2,1}=(23,22,21,20,19,18), T_{3,1}=(17,16,15,14,ρᵣ), T_{4,1}=(13,12,8), T_{4,2=}(7,6,2), T_{4,3=}(6,2,1), T_{5,1}=(11,10,9), and T_{6,1}=(5,4,3)

As shown in FIG. 7D, for this graph, nodes 21, 20, 2 and 6 are repeated nodes, which is unavoidable. This is due to the requirement for the minimum and maximum length of the generated test cases 625. As depicted, the final 6 selected test cases are each depicted in FIG. 7D by a closed curve.

For the second approach, in some embodiments, it may be based on having zero redundancy in the generated test cases may be applied. In embodiments in which zero redundancy in test cases is required, the required minimum length for the test cases may need to be identified first. Identifying the required minimum length may be done by analyzing all leaves and keeping non-repeated nodes in each leaf and finding the shortest length among them. Then, an approach similar to that used in the first approach above may be used to generated test cases (e.g. the first scenario).

Let Ωᵢ⊆γᵢ be a set that does not share any nodes with other leaves, defined as

$${Ω}_{i} = \{ {N}_{i} - {⋂}_{j = 1}^{p} {N}_{j} for j \neq i \} \qquad ( 22 )$$

Let's define Ω={Ω₁, Ω₂, . . . , Ωₚ} and the function ω(x)∈ [symbol] such that it calculates the sum of all elements in set x, as follows

$$ω ( x ) = {\sum }_{x ∈ x} x \qquad ( 23 )$$

The smallest set γₘ∈Ω is defined as

$${γ}_{m} = \{ x ∈ Ω \vert ∀ y ∈ Ω : ω ( x ) \leq ω ( y ) \} \qquad ( 24 )$$

Thus, the upper limit for the minimum length of test cases is obtained as

$${s}_{m} = ω ( {γ}_{m} ) \qquad ( 25 )$$

Therefore, having this limit can ensure zero redundancy in test case generation.

Returning to the tree graph depicted in FIG. 7A, an example is now provided in which test cases for a zero redundancy approach are generated. In this example, the generated test cases will cover all nodes and have zero redundancy (i.e. no repeated lane segments). For this scenario, test cases are generated along with the required minimum length (sₘ) for the test cases.

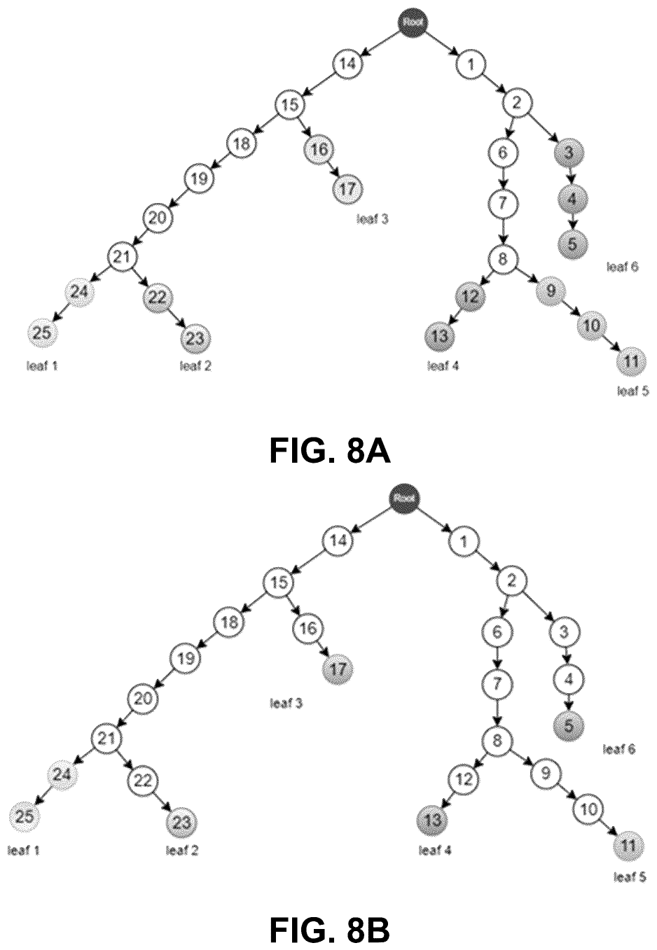

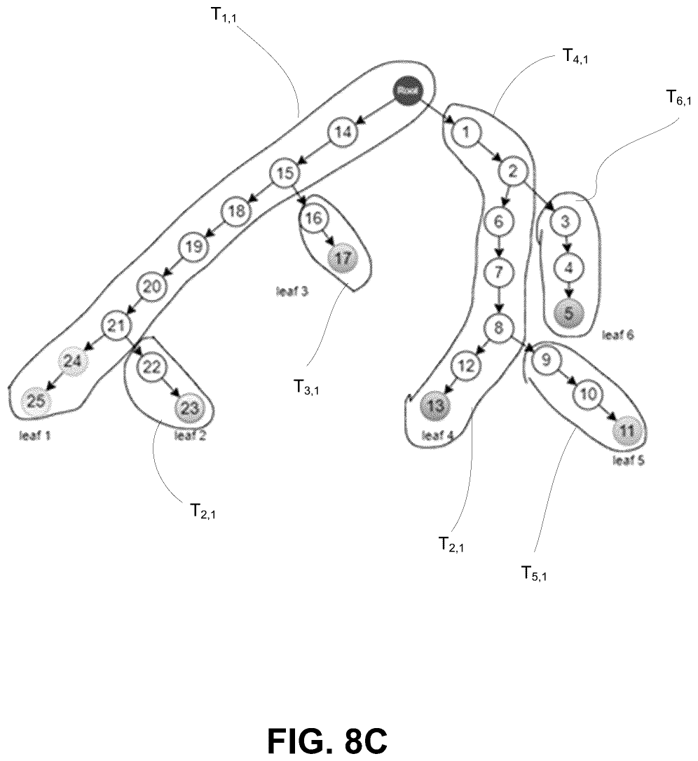

In the first step, we identify the minimum test case length (sₘ). First, we identify the tree leaves as L={l₁, l₁, . . . , l₆} and intersect all leaves, thus we have the following sets (the result is illustrated in FIG. 8A):
Ω₁={25,24}, Ω₂={23,22}, Ω₃={17,16}, Ω₄={13,12}, Ω₅={11,10,9}, and Ω₆={5,4,3}

The corresponding length of each segment is also calculated based on the table provided in FIG. 7B:
S(Ω₁)=2, S(Ω₂)=4, S(Ω₃)=5, S(Ω₄)=6.66, S(Ω₅)=14, S(Ω₆)=6.66

Thus, γₘ=2. In other words, 0≤sₘ≤2

In the second step, having the minimum test case length of sₘ=2, we have:
γ₁=(25,24), γ₂=(23), γ₃=(17), γ₄=(13), γ₅=(11), and γ₆=(5)

where the selected sequence of nodes for each leaf is shown with different shadings in FIG. 8B. Thus, FIG. 8B is a depiction of the minimum number of nodes for each leaf to prevent redundancy.

Thus, we have
Γ₀={25,24,23,17,13,11,5}

By considering s_{M}=∞, the set of test cases with zero number of repeated lane segments covering the whole tree (as depicted in FIG. 8C) is determined as follows:

By considering s_{M}=∞, the set of test cases with zero number of repeated lane segments covering the whole tree (see FIG. 8C) is determined as follows:
T_{1,1}=(25,24,21,20,19,18,15,14,ρᵣ), T_{2,1}=(23,22), T_{3,1}=(17,16), T_{4,1}=(13,12,8,7,6,2,1), T_{5,1}=(11,10,9), and T_{6,1}=(5,4,3)

At block 630, a set of test cases is selected. In some embodiments, the set of test cases is optimized. In some embodiments, the optimized set of test cases (T₀⊆T_{M}) is selected based on the generated set of test cases 625 corresponding to the identified variabilities and unvalidated lane segments. The generated test cases (T_{M}) is compared against the map variabilities and the previously validated lane segments to identify an optimized set of test cases (in some embodiments, the smallest set) that needs to be executed to fully cover the HD map.

Let denote Vᵤ as a set including unvalidated nodes and the nodes exist in map variabilities, defined as

$${V}_{u} = \{ {q}_{1} , {q}_{2} , {q}_{3} , … , {q}_{z} \} \qquad ( 26 )$$

then, an optimized set of test cases (T₀) is defined as

$${T}_{o} = \{ {T}_{i} ∈ {T}_{M} \vert {T}_{i} ⋂ {V}_{u} \neq \{ ∅ \} for i = [ 1 , … , y ] \} \qquad ( 27 )$$

where y=Σⱼ₌₁^{p}nⱼ.

At execution instance generation block 550, a set of execution instances may be built which enables parallel execution of test cases 545. In some embodiments, test cases are grouped into a given number of execution instances 555 so as to have roughly the same execution time. In some embodiments, selecting the appropriate test cases for each execution instance 555 may be done through an optimization process.

Let Iⱼ⊆T₀ To denote the j-th execution instance which includes a selection of cⱼ test cases defined as

$${I}_{j} = \{ {q}_{1} , {q}_{2} , … , {q}_{{c}_{j}} \vert {q}_{i} ∈ {T}_{o} for i = [ 1 , … , {c}_{j} ] \} \qquad ( 28 )$$

where cⱼ≤y is the total number of test cases in the j-th execution instance.

Let denote eₖ as the execution time (i.e., test size) of the k-th test case. The total execution time of the j-the execution instance (Eⱼ) is defined as

$${E}_{j} = {\sum }_{k = 1}^{{c}_{j}} {e}_{k} \qquad ( 29 )$$

having x test execution instances, the following vector can be defined as

$$F ( {E}_{1} , {E}_{2} , … , {E}_{x} ) = [ \begin{matrix}{E}_{1} - {E}_{2} \\ {E}_{1} - {E}_{3} \\ {E}_{1} - {E}_{4} \\ ⋮ \\ {E}_{1} - {E}_{x} \\ ⋮ \\ {E}_{x - 1} - {E}_{x}\end{matrix} ] \qquad ( 30 )$$

where the execution vector F is [symbol] ^{x×1}. For example, let's assume we have three execution instances (x=3), then, we will have

$$F ( {E}_{1} , {E}_{2} , {E}_{3} ) = [ \begin{matrix}{E}_{1} - {E}_{2} \\ {E}_{1} - {E}_{3} \\ {E}_{2} - {E}_{3}\end{matrix} ] \qquad ( 31 )$$

Finally, the optimization cost function can be defined as

$$H = {min}_{\{ {I}_{1} , {I}_{2} , … , {I}_{x} \}} {‖ F ( {E}_{1} , {E}_{2} , … , {E}_{x} ) ‖}_{2} \qquad ( 32 )$$

subjected to

$${\sum }_{j = 1}^{x} {c}_{j} = y \qquad ( 33 )$$

$$and$$

$${⋃}_{j = 1}^{x} {I}_{j} = {T}_{o} \qquad ( 34 )$$

$$and$$

$${⋂}_{j = 1}^{x} {I}_{j} = \{ ∅ \} \qquad ( 35 )$$

where ∥·∥₂ is the Euclidean norm, x is the total number of execution instances, y=|T₀| and cⱼ is the total number of test cases in the j-th execution instance. In some embodiments, this optimization process will lead E₁, E₂, . . . , E_{X} to be as close as possible to each other.

In some embodiments, test cases 545 may be stored in a text-based format (such as, for example, JSON). In some embodiments, each test case comprises a sequence of lane segments. Thus, each execution instances represented by a single JSON file may comprise an optimized set of test cases in terms of execution.

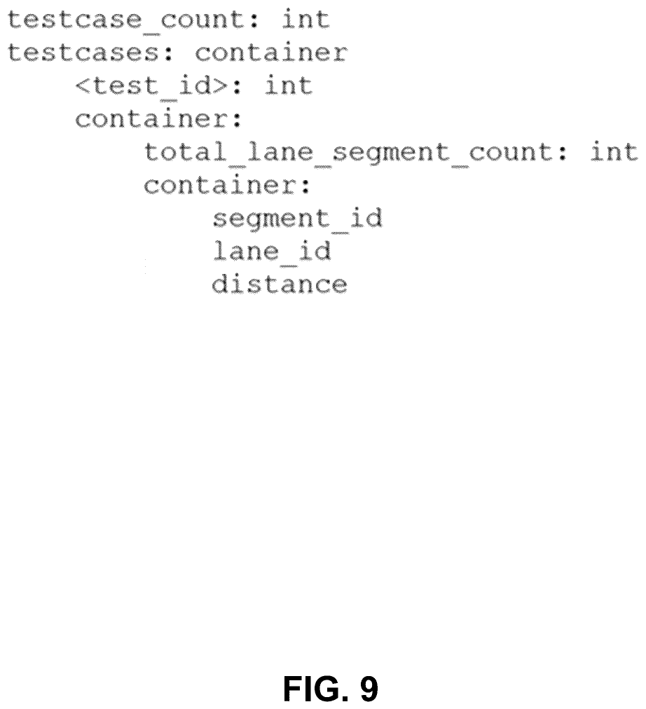

FIG. 9 depicts an example output schema for execution instances for the JSON format.

Some embodiments of systems and methods described herein may provide 100% coverage for a given HD map 502 within a reasonable testing time. The selection of test cases or routes 545 may be optimized for validating map features based on testing requirements. Some embodiments described herein may allow for improved efficiency in allocating testing resources by identifying variabilities of an HD map 502 and allowing for parallel execution of test cases in the form of execution instances 555.

In some embodiments, once map validation system 126 has generated optimized test cases 545 and the execution instances for a given HD map 502, these optimized test cases may be executed to validate the HD map 502. In some embodiments, test cases may be executed via simulation using one or more processors 114. In some embodiments, the validated HD map 502 may then be used as a basis for navigation of an autonomous vehicle 107. In some embodiments, a vehicle 107 may be dispatched along one or more routes of the optimized test cases 545 to collect additional data where it is determined that one or more attributes or features are not present in the map database 525.

Of course, the above-described embodiments are intended to be illustrative only and in no way limiting. The described embodiments are susceptible to many modifications of form, arrangement of parts, details, and order of operation. The invention is intended to encompass all such modifications within its scope, as defined by the claims.

### REFERENCES

[1] Rehrl, Karl, and Simon Gröchenig. “Evaluating Localization Accuracy of Automated Driving Systems.” Sensors 21.17 (2021): 5855.
[2] Fischer, Peter, et al. “Validation of HD Maps for autonomous driving.” Proceedings of the International Conference on Intelligent Transportation Systems in Theory and Practice mobil. TUM, Munich, Germany. 2017.
[3] Xia, Wanru. “High-definition map creation and update for autonomous driving.” (2021).
[4] Bhavsar, Sagar Ravi, et al. “Sensor fusion-based online map validation for autonomous driving.” 2020 IEEE Intelligent Vehicles Symposium (IV). IEEE, 2020.
[5] Fabris, Andrea, et al. “Online Map Validation for Autonomous Driving.” Proceedings of ACM Computer Science in Cars Symposium (CSCS). 2019.
[6] Fabris, Andrea, et al. “Correlation-based approach to online map validation.” 2020 IEEE Intelligent Vehicles Symposium (IV). IEEE, 2020.
[7] https://en.wikipedia.org/wiki/OpenDRIVE_(specification)
[8] Riveros, Cristian, Jorge Salas, and Oskar Skibski. “How to choose the root: centrality measures over tree structures.” arXiv preprint arXiv:2112.13736 (2021).
[9] https://en.wikipedia.org/wiki/Breadth-first_search

What is claimed is:

1. A method of validating a map for use with an autonomous vehicle, the method comprising:
obtaining a high definition (HD) map and a map schema associated therewith;
comparing, by a processor, said HD map to said map schema;
storing said HD map in a map database based on said comparing;
identifying one or more variabilities in said HD map;
generating, by the processor, a map graph based on said HD map, said map graph comprising nodes representing lane segments and edges representing connections between said lane segments;
generating, by the processor, a plurality of test cases based on the map graph, testing requirements, and at least one previously validated lane segment;
selecting an optimized set of test cases based on said plurality of generated test cases, said one or more variabilities in said HD map, and unvalidated lane segments in said HD map;
generating a plurality of execution instances, said optimized set of test cases being subdivided among said plurality of execution instances; and
validating said HD map by executing said plurality of execution instances.

2. The method of claim 1, wherein generating said map graph comprises parsing said HD map using a multithreaded parsing and thread synchronization mechanism, and storing parsed information in a list structure.

3. The method of claim 1, wherein each of said test cases comprises a map route comprising a plurality of lane segments to be validated.

4. The method of claim 1, wherein generating said plurality of test cases comprises generating a tree graph based on said map graph, wherein a root node of said tree graph is selected based on a node having a highest betweenness value.

5. The method of claim 4, wherein said plurality of test cases is generated so as to minimize redundancy given a constraint on a length of said test cases.

6. The method of claim 5, wherein said constraint on said length is a minimum length of said test cases.

7. The method of claim 5, wherein said constraint on said length is a maximum length of said test cases.

8. The method of claim 5, wherein said constraint on said length is a minimum length of said test cases and a maximum length of said test cases.

9. The method of claim 4, wherein said plurality of test cases is generated so as to have zero redundancy.

10. The method of claim 1, wherein said optimized set of test cases is subdivided among said plurality of execution instances so as to minimize a difference in execution time between each of said execution instances.

11. The method of claim 1, wherein said map schema includes a definition for each map element and attributes associated with each respective map element.

12. The method of claim 11, wherein said map elements include one or more of lane segments, road edges, and/or road markers.

13. The method of claim 1, wherein the map schema is in an XML Schema Definition format, and wherein said HD map is in an XML format.

14. The method of claim 1, wherein said testing requirements include at least one of application requirements and execution requirements.

15. The method of claim 1, wherein the map database includes previous versions of said HD map.

16. The method of claim 1, wherein said identifying one or more variabilities in said HD map is based on selecting an interested map feature as a variational point for said HD map relative to previous versions of said HD map.

17. The method of claim 1, further comprising generating a defect report based on said validating said HD map against said map schema.

18. The method of claim 17, wherein said defect report includes a discontinuity in a lane-level network of said HD map.

19. The method of claim 1, wherein said plurality of execution instances are executed in parallel.

20. A system for performing map validation, the system comprising:
one or more processors;
a non-transitory computer-readable storage medium having stored thereon computer-executable instructions that, when executed by the one or more processors, cause the one or more processors to:
obtain a high definition (HD) map and a map schema associated therewith;
compare said HD map to said map schema;
store said HD map in a map database based on said comparing;
identify one or more variabilities in said HD map;
generate a map graph based on said HD map, said map graph comprising nodes representing lane segments and edges representing connections between said lane segments;
generate a plurality of test cases based on the map graph, testing requirements, and at least one previously validated lane segment;
select an optimized set of test cases based on said plurality of generated test cases, said one or more variabilities in said HD map, and unvalidated lane segments in said HD map;
generate a plurality of execution instances, said optimized set of test cases being subdivided among said plurality of execution instances; and
validate said HD map by executing said plurality of execution instances.
